(19) United States
(12) Patent Application Publication
(10) Pub. No.: US 2025/0094687 A1
(43) Pub. Date: Mar. 20, 2025

(54) GENERATING SEMANTICALLY REPETITION-FREE LLM TEXT

(71) Applicant: Oracle International Corporation, Redwood Shores, CA (US)

(72) Inventors: Zheng Wang, Sammamish, WA (US); Yazhe Hu, Bellevue, WA (US); Mengqing Guo, Redmond, WA (US); Tao Sheng, Bellevue, WA (US); Jun Qian, Bellevue, WA (US); Vinod Murli Mamtani, Bellevue, WA (US)

(21) Appl. No.: 18/758,441

(22) Filed: Jun. 28, 2024

Related U.S. Application Data
(60) Provisional application No. 63/583,247, filed on Sep. 16, 2023.

(51) Int. Cl. G06F 40/166; G06F 40/253

(52) U.S. Cl. CPC G06F 40/166; G06F 40/253

(57) ABSTRACT

Techniques for generating repetition-free text using a large language model (LLM) are provided. In one technique, textual content that was generated by an LLM is accessed, where the textual content comprises a plurality of sub-components including a first sub-component and a second sub-component. A first embedding that represents the first sub-component is generated and a second embedding that represents the second sub-component is generated. Based on a similarity between the first embedding and the second embedding, it is determined whether the second sub-component is repetitious with respect to the first sub-component. In response to determining that the second sub-component is repetitious with respect to the first sub-component, at least a portion of the second sub-component is removed from the textual content.

### BENEFIT CLAIM

This application claims benefit under 35 U.S.C. § 119(e) of provisional application 63/583,247, filed Sep. 16, 2023, by Zheng Wang et al., the entire contents of which is hereby incorporated by reference.

### TECHNICAL FIELD

The present disclosure relates to large language models and, more particularly, to generating natural language text that is free of repetitions.

### BACKGROUND

Large language models (LLMs) are a type of deep learning model that combines a deep learning technique called attention in combination with a deep learning model type known as transformers to build predictive models. These predictive models encode and predict natural language writing. LLMs contain hundreds of billions of parameters trained on multiple terabytes of text. LLMs are trained to receive natural language as an input. Consequently, LLMs are extremely useful for generating natural-language answers to questions formulated in natural language. Since LLMs are trained on terabytes of text of many different types, including journals, articles, websites, and books, LLMs may not necessarily generate textual content that adheres to a desired set of grammatical rules. For example, content generated by LLMs is frequently repetitious.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example repetition removal system for identifying and removing repetitious text from textual content generated by an LLM, in an embodiment;

FIG. 2 is a block diagram that depicts an example embedding-based repetition detector, in an embodiment;

FIG. 3 is a flow diagram that depicts an example process for removing repetitions from LLM-generated textual content, in an embodiment;

FIG. 4 is a block diagram that illustrates a computer system upon which an embodiment of the invention may be implemented;

FIG. 5 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method are provided for identifying and removing repetitiveness within textual content that is generated by a Large Language Model (LLM). In one technique, a machine learning model generates embeddings that represent sub-components (e.g., phrases, sentences, or paragraphs) of an initial set of textual content generated by an LLM. Next, a similarity value is computed that represents a similarity between the embeddings. If the similarity value exceeds a threshold, then the corresponding sub-components are considered repetitive, even though the sub-components. When a pair of repetitive sub-components is identified, one of the sub-components of the pair is removed from the textual content to generate modified textual content.

However, the modified textual content may lack clarity, may include incomplete sentences, may include grammatical errors, or may otherwise be unsuitable for visual consumption. To address the potential issues with the modified textual content, in a related technique, the modified textual content is submitted back to the LLM (or another LLM) for generation of updated textual content, which may go through another repetition check before being returned as output.

In another technique, textual repetitions in textual content (generated by an LLM) are identified without using embeddings. A textual repetition may be the use of a particular word, phrase, or sentence more than a threshold number of times. Textual repetitions are identified and, optionally, removed. The textual content is submitted to the same or different LLM to rephrase the textual content. If the submitted textual content includes the identified repetitious content, then the submitted textual content identifies the repetitious content. If the submitted textual content excludes the identified repetitious content, then the prompt to the same or different LLM may also include the repetitious content.

Embodiments improve computer-related technology, namely LLM technology, by removing repetitious content that LLMs tend to generate.

### System Overview

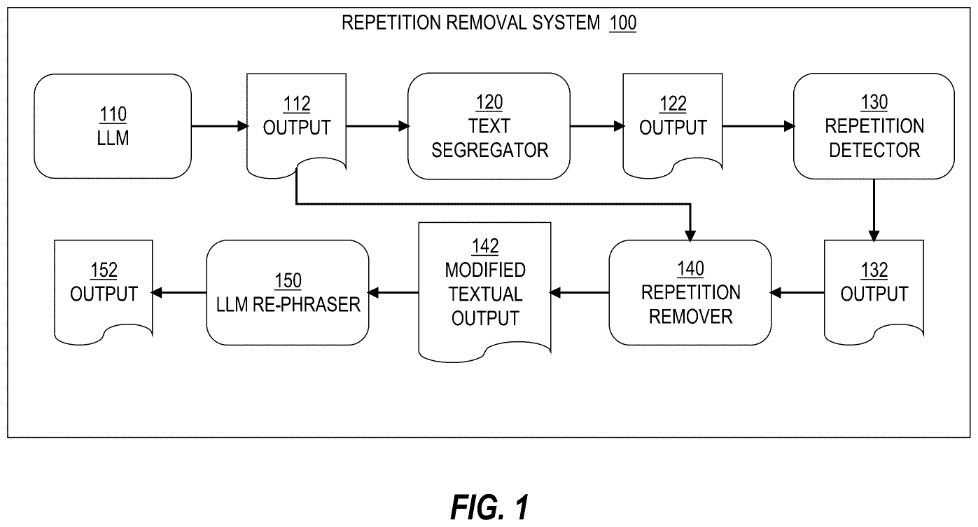

FIG. 1 is a block diagram that depicts an example repetition removal system 100 for identifying and removing repetitious text from textual content generated by an LLM, in an embodiment. Repetition removal system 100 comprises an LLM 110, a text segregator 120, a repetition detector 130, a repetition remover 140, and an LLM re-phraser 150. Each of LLM 110, text segregator 120, repetition detector 130, repetition remover 140, and LLM re-phraser 150 may be implemented in software, hardware, or any combination of software and hardware. Repetition removal system 100 may be implemented on an enterprise's premises or in a cloud that is provided by a cloud provider that is different than the enterprise that provides or supports repetition removal system 100.

LLM 110 receives a prompt to generate textual content. The prompt may include an instruction to summarize a set of one or more input documents, which may be included in the prompt or referenced in the prompt. Alternatively, the prompt may be to generate content based on one or more instructions included in the prompt. The prompt may originate from a computing device that is separate from and, optionally, remote relative to, repetition removal system 100. Examples of the computing device include desktop computer, a laptop computer, a tablet computer, and a smartphone. The computing device may be communicatively coupled with repetition removal system 100 via one or more wireless and/or wired communication networks, such as a local area network (LAN), a wide area network (WAN), and the Internet. In fact, repetition removal system 100 may be communicatively coupled to numerous computing devices, each of which submits a text generation request to repetition removal system 100.

LLM 110 generates output 112 based on the prompt the one or more instructions included therein. Output includes textual content and, optionally, image content and/or video content.

### Text Segregator

Text segregator 120 accepts output 112 as input and segregates, or divides, the textual content of output 112 into multiple portions or sub-components. A sub-component is a strict subset of the textual content of output 112 and comprises consecutive characters from that textual content.

For example, text segregator 120 segregates the textual content into individual words or tokens. A word may be delineated by whitespace and/or punctuation, such as periods, colons, and semi-colons. A word may include a hyphenated word or two words that are connected with a hyphen or dash character. A word may be found in a dictionary, may be slang that is not found in a dictionary, or may be a misspelling of a word found in a dictionary.

As another example, text segregator 120 segregates the textual content of output 112 into sentences. A sentence is delineated by periods. A sentence may also be delineated by other characters, such as colons or semi-colons. Furthermore, text segregator 120 may generate multiple sentences from a single sentence. For example, a sentence may include a preamble and a list of items (e.g., phrases or words), where each item appended to the preamble could be a separate sentence.

As another example, text segregator 120 segregates the textual content of output 112 into paragraphs. A paragraph may be delineated by carriage returns and/or other characters or control characters found in the textual content. If the textual content of output 112 does not include any carriage returns or other pre-defined control characters that indicate paragraph delineation, then the textual content may be considered to not have any paragraphs.

As another example, text segregator 120 segregates the textual content of output 112 into phrases. A phrase is a strict subset of a sentence, such as an item in a list of items in a sentence. Text segregator 120 may determine that a sentence does not include any phrases. Such a determination may be based on the length of the sentence and/or other characteristics of the sentence, such as not having any commas or other characters (e.g., colon, semi-colon). Thus, it may be possible that text segregator 120 identifies zero or relatively few phrases in the textual content of output 112.

In an embodiment, text segregator 120 segregates the textual content at multiple levels of text granularity. For example, text segregator 120 segregates the textual content into words, phrases, sentences, and paragraphs, or two or three from this list. Thus, test segregator 120 may identify: (1) a phrase as a sub-component of the textual content of output 112; (2) a sentence that includes the phrase; and (3) a paragraph that includes the sentence.

Text segregator 120 generates output 122, which comprises a set of sub-components, which may include words, phrases, sentences, and/or paragraphs.

### Repetition Detector

Output 122 is input to repetition detector 130, which detects or identifies repetitions in output 122. Some repetitions are acceptable; others are not. For example, repetitions of a proper noun, such as a person's name or the name of a city, may be acceptable up to a certain limit. Any instances of the proper noun that go beyond that limit are considered too repetitious. Proper nouns may be replaced by pronouns, such as it, he, or she, depending on the pronoun. If the instances of a word satisfy certain repetition criteria, then the instances (or at least the latter instances) are considered repetitious. The first one or two instances are not considered repetitious.

In an embodiment, repetition detector 130 applies different repetition criteria to different types of words. For example, repetition criteria for a proper noun may be the existence of over three instances of the proper noun within any one hundred consecutive characters of text, while repetition criteria for an adjective may be existence of over two instances of the adjective within any fifty consecutive characters of text, while repetition criteria for a verb may be the existence of over two instances of the verb (or roots, thereof) within any thirty consecutive characters of text.

In an embodiment, for non-word sub-components, repetition detector 130 uses embeddings to detect repetitions in output 122. In this embodiment, repetition detector 130 includes an embedding generator, or a language model, such as BERT (Bidirectional Encoder Representations from Transformers). BERT is a language model that is based on the transformer architecture, notable for its dramatic improvement over previous state of the art models. A sub-component, such as a phrase or sentence, is input to the embedding generator, which generates an embedding, which is a vector of n-dimensional values. In a related embodiment, the embedding generator is trained using one or more machine learning techniques such that the embedding generator, given two textual inputs that are semantically similar, will produce two embeddings or vectors that are similar or close in the embedding space.

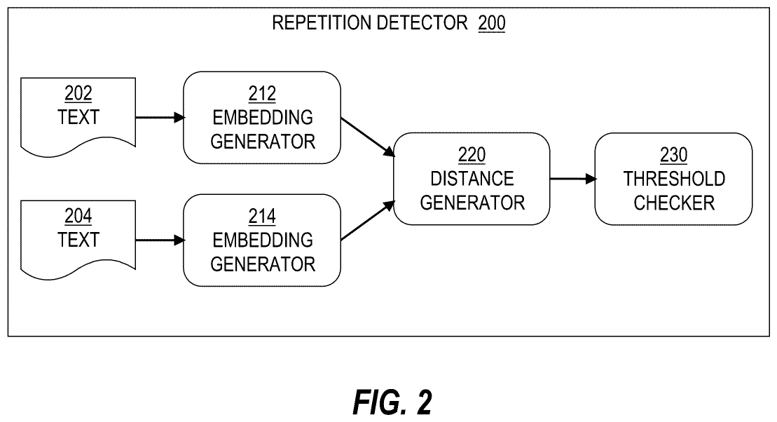

FIG. 2 is a block diagram that depicts an example embedding-based repetition detector 200, in an embodiment. Detector 200 may be part of repetition detector 130. FIG. 2 depicts two different text inputs (text 202 and text 204), two embedding generators 212 and 214, distance generator 220, and threshold checker 230. While two embedding generators 212 and 214 are depicted, such embedding generators may be the same embedding generator, or may be two instances of the same embedding generator. For example, text 202 and text 204 may be input serially to a single embedding generator. As another example, text 202 and text 204 may be input concurrently into different instances of the same embedding generator. Distance generator 220 generates a distance measure based on the embeddings generated by embedding generators 212 and 214. The distance measure is input to threshold checker 230, which generates output that indicates whether the respective texts are sufficiently similar. If the output indicates that text 202 and text 204 are sufficiently similar, then detector 200 determines that the two texts are repetitious. Otherwise, detector 200 determines that the two texts are not repetitious.

Two embeddings (and therefore the sub-components that they represent) are considered similar if a similarity value that repetition detector 130 computes is below (or above) a certain threshold. In one implementation, if two embeddings are identical, then the similarity value is zero; thus, if the similarity value computed from two embeddings is below a certain threshold, then the corresponding sub-components are considered repetitious. One example measure of similarity of two embeddings is cosine similarity, although embodiments are not so limited.

In an embodiment, all pairs of sub-components (e.g., phrases and/or sentences) are compared to each other in order to detect repetitions among the sub-components in the textual content of output 112. However, in some situations, doing so would require a lot of computing resources, such as leveraging the embedding generator, which may be expensive in terms of computing resources and/or time to generate the embeddings. In an alternative embodiment, only pairs of sub-components that satisfy certain criteria are considered for generating embeddings. For example, if a pair of sub-components have a certain level of textual similarity, then embeddings are generated for the pair of sub-components. Textual similarity may be defined as the number of words in the sub-components that textually match relative to the total number of words (or characters) in the shorter (or longer) of the two sub-components. A textual match may be an exact match or a non-exact match, such as when one word is a variation of the other. For example, “earth” and “earthy” do not match exactly, but they are considered a textual match because one is a subset of the other. As another example, two words from different sub-components may match if both words share the same root or derivation. Textual similarity may or may not take into account the size of the sub-components. For example, the longer that one or two of the sub-components are, the most textual matching may be required in order to determine to generate embeddings for the two sub-components.

In an embodiment, the above process (for determining whether two phrases or sentences are repetitious) may be used for determining whether two paragraphs are repetitious. However, some embedding generators may have a token or character limit, meaning that if the size of a paragraph is larger than the limit, then the entire paragraph cannot be input into the embedding generators. In this situation, in an embodiment, repetition detector 130 includes a summarizer that generates a summary of a paragraph. The summarizer may be the same LLM as LLM 110 or may be a different LLM than LLM 110. For example, the summarizer may be an LLM that is trained mainly for summarizing text. When generating the summary, repetition detector 130 may generate a prompt that requests the summarizer to generate a summary that is less than a certain number of characters or that is less than a certain number of bytes, which is the “window size” of the embedding generator.

Repetition detector 130 generates output 132 that indicates zero or more repetitions in the textual content of output 112. Output 132 identifies each instance of repetition, which may be one or more words, one or more phrases, one or more sentences, and/or one or more paragraphs. Output 132 may identify a repetition in one or more ways. For example, output 132 may include a start offset that points to the beginning of a repetitious sub-component (in the textual content) and an end offset that points to the end of the repetitious sub-component (in the textual content). As another example, output 132 may be a copy of the textual content of output 112, except that it includes markers or text indicators that inform a processor of output 132 which sub-components are to be removed.

Output 132 may identify all instances of a sub-component that is considered repetitious relative to each other or just the instances of the sub-component that exceed repetition criteria. For example, for two sentences that are considered similar, output 132 may identify just the second of the two sentences (as they appear in the textual content) or may identify both sentences.

### Repetition Remover

Repetition remover 140 uses output 132 to remove repetitious sub-components from the textual content of output 112. Repetition remover 140 may remove words, phrases, sentences, and/or paragraphs from the textual content. For example, repetition remover 140 may remove two words, one phrase, zero sentences, and one paragraph from the textual content of output 112. A result of repetition remover 140 is modified textual content 142, which may be a copy of the textual content of output 112, but without the repetitious sub-components.

Depending on the type of sub-component (e.g., word, phrase, sentence, or paragraph), additional processing may or may not be necessary. For example, if a paragraph is removed, then no additional processing of the textual content of output 112 in light of that paragraph may be performed. (For example, other sub-components may have been identified for removal and additional processing may be prudent in light of that removal.) Similarly, if a sentence is removed, then no additional processing of the textual content in light of that sentence removal may be performed. However, if a word or phrase is removed from the textual content, then the sentence in which the word or phrase originally appeared may be modified.

### LLM Re-Phraser

LLM re-phraser 150 may be the same as LLM 110 or may be a different LLM altogether. For example, LLM re-phraser 150 may have been specifically trained, using one or more machine learning techniques, to re-phrase sentences or paragraphs.

In an embodiment, LLM re-phraser 150 receives modified textual content 142, or a portion thereof, as input and generates rephrased output 152. For example, in the case of a repetitious phrase or word, LLM re-phraser 150 receives the original sentence that includes the phrase/word and a prompt that instructs LLM re-phraser 150 to rephrase the sentence without the phrase/word. The LLM re-phraser 150 may also receive, as input, one or more sentences that appear (in the textual content of output 112) before the original sentence that includes the phrase/word and/or one or more sentences that appear (in the textual content of output 112) after the original sentence.

In a related embodiment, in the context of a repetitious word, LLM re-phraser 150 receives a prompt that instructs LLM re-phraser 150 to replace the repetitious word with a synonym.

As another example, in the case of a repetitious sentence, LLM re-phraser 150 receives: (1) the repetitious sentence; (2) one or more sentences that appear before or after the repetitious sentence in the textual content of output 112; and (3) a prompt that instructs LLM re-phraser 150 to rephrase the one or more sentences without using the repetitious sentence. In a related example, instead of providing the repetitious sentence to LLM re-phraser 150, just (a) the one or more surrounding sentences (e.g., two sentences before the repetitious sentence and one sentence after the repetitious sentence) and (b) a prompt that instructs LLM re-phraser 150 to rephrase the one or more surrounding sentences are provided to LLM re-phraser 150.

In the context where the repetitious sub-component is a paragraph, LLM re-phraser 150 might not be invoked by repetition remover 140 (or another component of system 100). Instead, it may be assumed that the textual content of output 112 might still read or flow sufficiently well without the repetitious paragraph.

LLM re-phraser 150 outputs a response 152 that excludes the one or more sub-components from the textual content of output 112 that were considered repetitious. LLM re-phraser 150 (or another component of system 100) causes response 152 to be stored in persistent storage (e.g., disk storage) and/or in remote storage (e.g., in cloud storage), and/or transmitted to a computing device, which may be the same device that sent a generation request to system 100, which request triggered the generation of response 152. Alternatively, response 152 may be transmitted to a computing device that did not send such a generation request.

### Process Overview

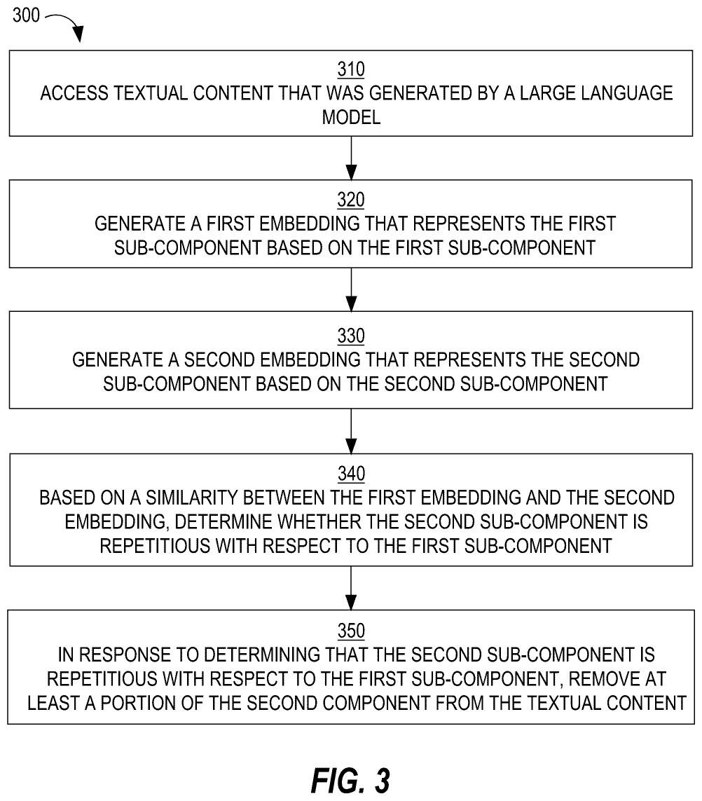

FIG. 3 is a flow diagram that depicts an example process 300 for removing repetitions from LLM-generated textual content, in an embodiment. Process 300 may be performed by different elements of system 100.

At block 310, textual content that was generated by an LLM is accessed. Block 310 may be preceded by receiving a prompt to generate content, where the prompt includes one or more instructions, and submitting the prompt to the LLM, which generates the textual content. The textual content comprises a plurality of sub-components that includes a first sub-component and a second sub-component. The textual content may have been stored in persistent (or non-volatile) storage (e.g., disk storage) between the time of generation and the time of accessing. Alternatively, the textual content may have only been stored in volatile storage between the two times. The sub-components may be words, phrases, sentences, paragraphs, or sections that comprise multiple paragraphs and/or non-paragraph portions of text.

At block 320, a first embedding that represents the first sub-component is generated based on the first sub-component. The first embedding may be generated by a machine-learned model (e.g., another language model) that receives the first sub-component as input. If the first sub-component is a paragraph or section, then block 320 may first comprise generating a summary (e.g., using the LLM or another LLM that is trained to summarize text) and then inputting the summary into the machine-learned model.

Block 320 may be preceded by a determination of whether the first sub-component and the second sub-component sufficiently match textually. For example, if the two sub-components are sentences, then this determination may involve determining whether there are a threshold number of matching words or matching key words among the two sentences.

At block 330, a second embedding that represents the second sub-component is generated based on the second sub-component. Block 330 may be similar to block 320, except that the second sub-component is involved, not the first sub-component. Thus, the same machine-learned model that generated the first embedding also generates the second embedding.

At block 340, based on a similarity between the first embedding and the second embedding, it is determined whether the second sub-component is repetitious with respect to the first sub-component. Block 340 may involve computing a similarity (such as a cosine similarity score or another similarity measure) based on the first embedding and the second embedding. If the similarity is greater (or less) than a certain threshold, then the respective embeddings are considered sufficiently similar and, thus, the corresponding sub-components that the embeddings represent are sufficiently similar.

At block 350, in response to determining that the second sub-component is repetitious with respect to the first sub-component, at least a portion of the second sub-component from the textual content is removed. For example, the entirety of the second sub-component is removed. As another example, a clause or phrase in the second sub-component is removed.

Process 300 may proceed with a re-phrase block that involves prompting the LLM (or another LLM) to re-phrase the second sub-component (if the entirety of the second sub-component is not removed). Such a block may also involve inputting the first sub-component along with the second sub-component (or a portion thereof) so that the LLM has more information about what is repetitious.

Blocks 320-350 may repeat for multiple pairs of sub-components detected in the textual content. Some pairs of sub-components may be phrases while some pairs of sub-components may be sentences or paragraphs.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

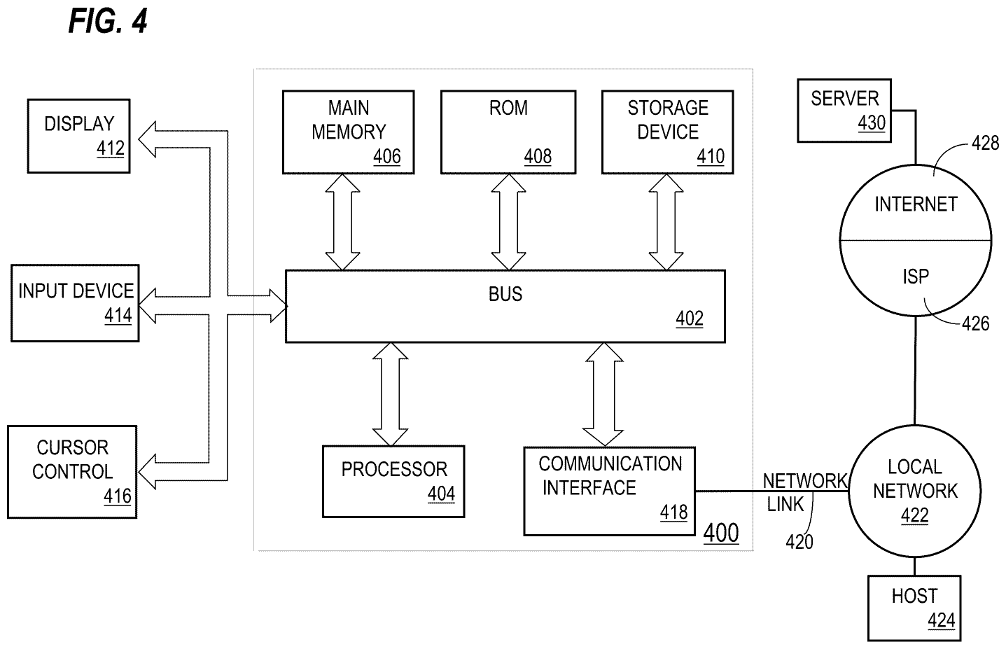

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

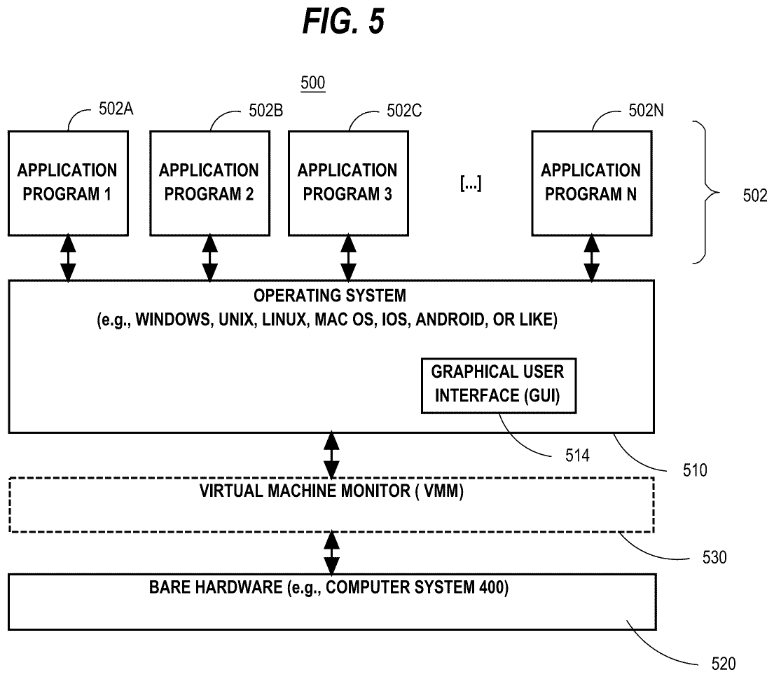

FIG. 5 is a block diagram of a basic software system 500 that may be employed for controlling the operation of computer system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computer system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
accessing textual content that was generated by a large language model (LLM), wherein the textual content comprises a plurality of sub-components including a first sub-component and a second sub-component;
generating a first embedding that represents the first sub-component;
generating a second embedding that represents the second sub-component;
based on a similarity between the first embedding and the second embedding, determining whether the second sub-component is repetitious with respect to the first sub-component;
in response to determining that the second sub-component is repetitious with respect to the first sub-component, removing at least a portion of the second sub-component from the textual content;
wherein the method is performed by one or more computing devices.

2. The method of claim 1, wherein the textual content is first textual content, wherein removing the portion of the second sub-component from the textual content results in modified textual content, further comprising:
submitting, to a second LLM to generate a second textual content that is different than the first textual content, the modified textual content and a prompt to re-phrase the modified textual content.

3. The method of claim 1, further comprising, prior to generating the first embedding and the second embedding:
determining whether the first sub-component matches the second sub-component at a target level of textual granularity;
wherein generating the first and second embeddings are performed in response to determining that the first sub-component matches the second sub-component at the target level of textual granularity.

4. The method of claim 1, further comprising:
submitting, to a second LLM, the first sub-component and a first prompt to summarize the first sub-component, wherein the second LLM outputs, based on the first sub-component and the first prompt, a first summary of the first sub-component;
submitting, to the second LLM, the second sub-component and a second prompt to summarize the second sub-component, wherein the second LLM outputs, based on the second sub-component and the second prompt, a second summary of the second sub-component;
wherein generating the first embedding comprises inputting the first summary into a language model that generates the first embedding based on the first summary;
wherein generating the second embedding comprises inputting the second summary into the language model that generates the second embedding based on the second summary.

5. The method of claim 1, wherein:
the plurality of sub-components includes a third sub-component and a fourth sub-component;
the first sub-component and the second sub-component correspond to a first level of granularity of a plurality of levels of granularity;
the third sub-component and the fourth sub-component correspond to a second level of granularity, of the plurality of levels of granularity, that is different than the first level of granularity;
the plurality of levels of granularity comprises one or more of a word, a phrase, a sentence, or a paragraph;
wherein the method further comprises:
generating a third embedding that represents the third sub-component;
generating a fourth embedding that represents the fourth sub-component;
based on a similarity between the third embedding and the fourth embedding, determining whether the fourth sub-component is repetitious with respect to the third sub-component;
in response to determining that the fourth sub-component is repetitious with respect to the third sub-component, removing at least a portion of the fourth sub-component from the textual content.

6. The method of claim 1, further comprising:
determining a frequency, in the textual content, of a particular word; and
in response to determining that the frequency meets one or more content modification criteria, removing one or more occurrences of the particular word from the textual content.

7. The method of claim 1, further comprising:
computing a cosine similarity value based on the first embedding and the second embedding;
determining whether the cosine similarity value exceeds a particular threshold value;
wherein removing is performed in response to determining that the cosine similarity value exceeds the particular threshold value.

8. The method of claim 1, wherein:
generating the first embedding comprises inputting the first sub-component to a machine-learned model; and
generating the second embedding at least by applying the machine-learned model the second sub-component.

9. A method comprising:
accessing first textual content that was generated by a large language model (LLM), wherein the first textual content comprises a plurality of sub-components including a first sub-component and a second sub-component;
based on a similarity between the first sub-component and the second sub-component, determining whether the second sub-component is repetitious with respect to the first sub-component;
in response to determining that the second sub-component is repetitious with respect to the first sub-component, removing at least a portion of the second sub-component from the first textual content to generate modified textual content;
submitting, to a second LLM, the modified textual content and a prompt to rephrase the modified textual content;
accessing second textual content that is generated by the second LLM based on the modified textual content and the prompt;
wherein the method is performed by one or more computing devices.

10. The method of claim 9, wherein:
the first sub-component and the second sub-component are two instances of a particular word;
removing the portion of the second sub-component comprises removing one of the two instances of the particular word.

11. The method of claim 9, wherein:
the first sub-component and the second sub-component are different phrases, different sentences, or different paragraphs within the first textual content;
the method further comprising:
generating a first embedding that represents the first sub-component;
generating a second embedding that represents the second sub-component;
the similarity is a similarity between the first embedding and the second embedding.

12. One or more non-transitory storage media storing instructions which, when executed by one or more computing devices, cause:
accessing textual content that was generated by a large language model (LLM), wherein the textual content comprises a plurality of sub-components including a first sub-component and a second sub-component;
generating a first embedding that represents the first sub-component;
generating a second embedding that represents the second sub-component;
based on a similarity between the first embedding and the second embedding, determining whether the second sub-component is repetitious with respect to the first sub-component;
in response to determining that the second sub-component is repetitious with respect to the first sub-component, removing at least a portion of the second sub-component from the textual content.

13. The one or more storage media of claim 12, wherein the textual content is first textual content, wherein removing the portion of the second sub-component from the textual content results in modified textual content, wherein the instructions, when executed by the one or more computing devices, further cause:
submitting, to a second LLM to generate a second textual content that is different than the first textual content, the modified textual content and a prompt to re-phrase the modified textual content.

14. The one or more storage media of claim 12, wherein the instructions, when executed by the one or more computing devices, further cause, prior to generating the first embedding and the second embedding:
determining whether the first sub-component matches the second sub-component at a target level of textual granularity;
wherein generating the first and second embeddings are performed in response to determining that the first sub-component matches the second sub-component at the target level of textual granularity.

15. The one or more storage media of claim 12, wherein the instructions, when executed by the one or more computing devices, further cause:
submitting, to a second LLM, the first sub-component and a first prompt to summarize the first sub-component, wherein the second LLM outputs, based on the first sub-component and the first prompt, a first summary of the first sub-component;
submitting, to the second LLM, the second sub-component and a second prompt to summarize the second sub-component, wherein the second LLM outputs, based on the second sub-component and the second prompt, a second summary of the second sub-component;
wherein generating the first embedding comprises inputting the first summary into a language model that generates the first embedding based on the first summary;
wherein generating the second embedding comprises inputting the second summary into the language model that generates the second embedding based on the second summary.

16. The one or more storage media of claim 12, wherein:
the plurality of sub-components includes a third sub-component and a fourth sub-component;
the first sub-component and the second sub-component correspond to a first level of granularity of a plurality of levels of granularity;
the third sub-component and the fourth sub-component correspond to a second level of granularity, of the plurality of levels of granularity, that is different than the first level of granularity;
the plurality of levels of granularity comprises one or more of a word, a phrase, a sentence, or a paragraph;
wherein the instructions, when executed by the one or more computing devices, further cause:
generating a third embedding that represents the third sub-component;
generating a fourth embedding that represents the fourth sub-component;
based on a similarity between the third embedding and the fourth embedding, determining whether the fourth sub-component is repetitious with respect to the third sub-component;
in response to determining that the fourth sub-component is repetitious with respect to the third sub-component, removing at least a portion of the fourth sub-component from the textual content.

17. The one or more storage media of claim 12, wherein the instructions, when executed by the one or more computing devices, further cause:
determining a frequency, in the textual content, of a particular word; and
in response to determining that the frequency meets one or more content modification criteria, removing one or more occurrences of the particular word from the textual content.

18. The one or more storage media of claim 12, wherein the instructions, when executed by the one or more computing devices, further cause:
computing a cosine similarity value based on the first embedding and the second embedding;
determining whether the cosine similarity value exceeds a particular threshold value;
wherein removing is performed in response to determining that the cosine similarity value exceeds the particular threshold value.

19. The one or more storage media of claim 12, wherein:
generating the first embedding comprises inputting the first sub-component to a machine-learned model; and
generating the second embedding at least by applying the machine-learned model the second sub-component.

20. One or more non-transitory storage media storing instructions which, when executed by one or more computing devices, cause performance of the method recited in claim 9.
